(19) United States
(12) Patent Application Publication
(10) Pub. No.: US 2008/0279453 A1
(43) Pub. Date: Nov. 13, 2008

(54) OCR enabled hand-held device

(76) Inventor: Brant L. Candelore, San Diego, CA (US)

Correspondence Address: MILLER PATENT SERVICES, 2500 DOCKERY LANE, RALEIGH, NC, 27606, US

(21) Appl. No.: 11/800,925

(22) Filed: May 8, 2007

(51) Int. Cl. G06K 9/34; G03B 21/00; G06K 9/22

(52) U.S. Cl. 382/176; 345/156; 353/42; 382/313

(57) ABSTRACT

A method of processing image data consistent with certain embodiments involves defining a segment of a visual field using a laser pointer; capturing an image of the segment of the visual field; and processing the captured segment to produce associated text associated with the selected segment. This abstract is not to be considered limiting, since other embodiments may deviate from the features described in this abstract.

### CROSS REFERENCE TO RELATED DOCUMENTS

This application is related to U.S. Provisional Patent Application No. 60/853,873 filed Oct. 23, 2006 to Brant L. Candelore; U.S. patent application Ser. No. 11/706,919 filed Feb. 14, 2007, docket number SNY-V8405.01 to Brant L. Candelore and Toshiro Ozawa entitled “Capture of Television Metadata Via OCR”; U.S. patent application Ser. No. 11/706,918 filed Feb. 14, 2007, docket number SNY-V8405.02 to Brant L. Candelore entitled “Trial Selection of STB Remote Control Codes”; U.S. patent application Ser. No. 11/706,529 filed Feb. 14, 2007, docket number SNY-W8625.01 to Brant L. Candelore entitled “Capture of Configuration and Service Provider Data Via OCR”; and U.S. patent application Ser. No. 11/706,890 filed Feb. 14, 2007, docket number SNY-W8632.01 to Brant L. Candelore entitled “Transfer of Metadata Using Video Frames”; each of which is hereby incorporated by reference herein.

### COPYRIGHT AND TRADEMARK NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever. Trademarks are the property of their respective owners.

### BACKGROUND

The majority of US households receive television content through cable television systems. Such systems have traditionally used a few OEM suppliers of hardware (e.g., set top boxes) and have not provided for integration of non-security navigation functionality of set-top boxes directly into digital TV sets. Under the so called “Plug and Play” agreement, the CableCARD™ adapter card was standardized as a way to adapt consumer electronics (CE) “navigation” devices to cable networks. While CableCARD™ standardization had promise, it was crippled by a lack of cable operator support, access to only a 1-way, lower tier of service, and no service-supplied metadata. With the advent of Switch Digital service, cable operators are further depreciating 1-way service by eliminating access to even some of the “basic” content.

Cable television Multiple Service Operators (MSOs) are presently establishing a new digital TV standard referred to as Open Cable Application Platform (OCAP) which will provide access to enhanced, 2-way functionality with unrestricted access to premium and high-value interactive services. Under this scenario, metadata (and the user interface) will be managed by OCAP applets downloaded to set-top boxes sold at retail. There is discussion about downloading OCAP applets to devices connected to those set-top boxes—so called “endpoints” in the home network. In this way, the cable operators can be assured of the “proper display” of their user interface when playing back cable content.

Unfortunately, under the OCAP model, CE manufacturers remain stymied because there does not appear to be a way to gain access to the metadata in order to create an alternative user interface to that supplied via the OCAP application. It is currently not possible to manage content in new ways that the customer might find compelling. Hence, this standard may force consumer electronics companies to conform to the user interfaces (UIs), Electronic Program Guides (EPGs), download protocols, and feature sets, defined by the MSOs using the OCAP standard. Unless a television receiver device such as a TV conforms to the OCAP standard (and its associated restrictions), it will be unable, among other things, to receive the meta-data related to the digital content. Without this meta-data, the television receiver will be unable to display any information related to the content including EPG descriptive material. As a result, improvements in technology, improved user interfaces and other features developed by such consumer electronics companies that are incompatible with the MSO supplied OCAP interface may be unusable in an OCAP environment. Additionally, the consumer will be stuck with whatever user interface and EPG capabilities their cable television supplier wishes to provide.

Internet services exist that can provide the desired descriptive material, however, to use such services, it is generally necessary to know the service provider, the time, and the channel number of the program being viewed. In a configuration where the STB is simply streaming decoded video to the TV (i.e., the STB is used just as a tuner/decoder), the virtual channel number associated with the video is unknown. Without the virtual channel number, Internet services that provide meta-data or descriptive material cannot be used.

In addition to controlling access to metadata used to generate electronic program guides and the like, the power exercised by the service providers in controlling such data also inhibits CE manufacturers from being able to offer innovative service enhancements, such as interactivity and interaction of the television with the Internet.

The above-referenced patent applications provide several techniques that are useful in addressing these problems. The present application presents another tool that can be brought to bear on the issue and provides enhanced services that can be made available to any suitable hand-held device.

### BRIEF DESCRIPTION OF THE DRAWINGS

Certain illustrative embodiments illustrating organization and method of operation, together with objects and advantages may be best understood by reference detailed description that follows taken in conjunction with the accompanying drawings in which:

FIG. 1 is a block diagram of an apparatus consistent with certain embodiments of the present invention.

FIG. 2 is a flow chart depicting operation of certain embodiments consistent with the present invention.

FIG. 3 is an illustration of a laser path used to draw a box to outline a selected segment of a visible field in a manner consistent with certain embodiments of the present invention.

FIG. 4 is an illustration of both vertical and horizontal expanding and contracting of the laser path used to draw a box to outline a selected segment of a visible field in a manner consistent with certain embodiments of the present invention.

FIG. 5 is an illustration of vertical expansion of the laser path used to draw a box to outline a selected segment of a visible field in a manner consistent with certain embodiments of the present invention.

FIG. 6 is an illustration of an alternative laser path used to draw a pair of brackets to identify a selected segment of a visible field in a manner consistent with certain embodiments of the present invention.

FIG. 7 is a flow chart of a process for operation of a hand-held apparatus in a manner consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically. The term “program” or “computer program” or similar terms, as used herein, is defined as a sequence of instructions designed for execution on a computer system. A “program”, or “computer program”, may include a subroutine, a function, a procedure, an object method, an object implementation, in an executable application, an applet, a servlet, a source code, an object code, a shared library/dynamic load library and/or other sequence of instructions designed for execution on a computer system.

Reference throughout this document to “one embodiment”, “certain embodiments”, “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

The term “program”, as used herein, may also be used in a second context (the above definition being for the first context). In the second context, the term is used in the sense of a “television program”. In this context, the term is used to mean any coherent sequence of audio video content such as those which would be interpreted as and reported in an electronic program guide (EPG) as a single television program, without regard for whether the content is a movie, sporting event, segment of a multi-part series, news broadcast, etc. The term may also be interpreted to encompass commercial spots and other program-like content which may not be reported as a program in an electronic program guide.

The term “visible field” as used herein is intended to encompass all elements visible to an individual. As used herein, selecting a segment of the visible field means to highlight or identify in some manner a portion of the visible field. By way of example, but not limitation, the segment can be highlighted or identified, for example by rapidly and repeatedly drawing a circle or box around the selected segment using a computer guided laser pointer device. In other embodiments, such laser pointer device can be modulated so as to produce a pair of brackets that can be stretched vertically and spaced horizontally using computer control. In this manner, projected light from the laser pointer device can highlight a selected segment of a visible field in a manner similar to, but more precise than, that used by a lecturer who points such a device at an image in his or her visible field and rapidly encircles it with light from the laser pointer.

In the field of computers and consumer electronics, when a mouse or other pointing device is used to select from a menu or select text or images from within a computer program or game, the pointing mechanism is implemented as an integral part of the controlling software or hardware. Thus, when a mouse is moved or a navigation button or control activated, a pointing or highlighting mechanism is controlled to produce a change in the image displayed. For example, when a mouse is pushed away from a computer user, generally an icon representing a pointer (e.g., an arrow) moves toward the top of a computer display. Similarly, if a navigation button is activated or a mouse is moved to the right the icon moves to the right on the screen display. This icon, in each case, is generated and displayed on the screen by the same hardware and software that generates other screen elements such as text and pictures. As such, the two mechanisms are intimately linked thus prohibiting one, for example, one from being able to select objects or text outside the bounds of the screen but within the user's field of view. Also, the user is prohibited from interacting with, for example, an on screen display that is generated outside a television set using the television set's own remote control.

One example of this is when an MSO provides an on screen display (OSD) of an electronic programming guide that is provided as a signal from a television set top box. The user must utilize the MSO's remote controller to navigate through such OSD, and generally speaking, the television's remote controller is unable to interact with such OSD.

In certain embodiments consistent with the present invention, a mechanism is provided that unlinks the pointing mechanism from the source of the signal. Moreover, the pointing mechanism consistent with certain embodiments can interact with the world outside a television or computer monitor thereby freeing the user from traditional constraints.

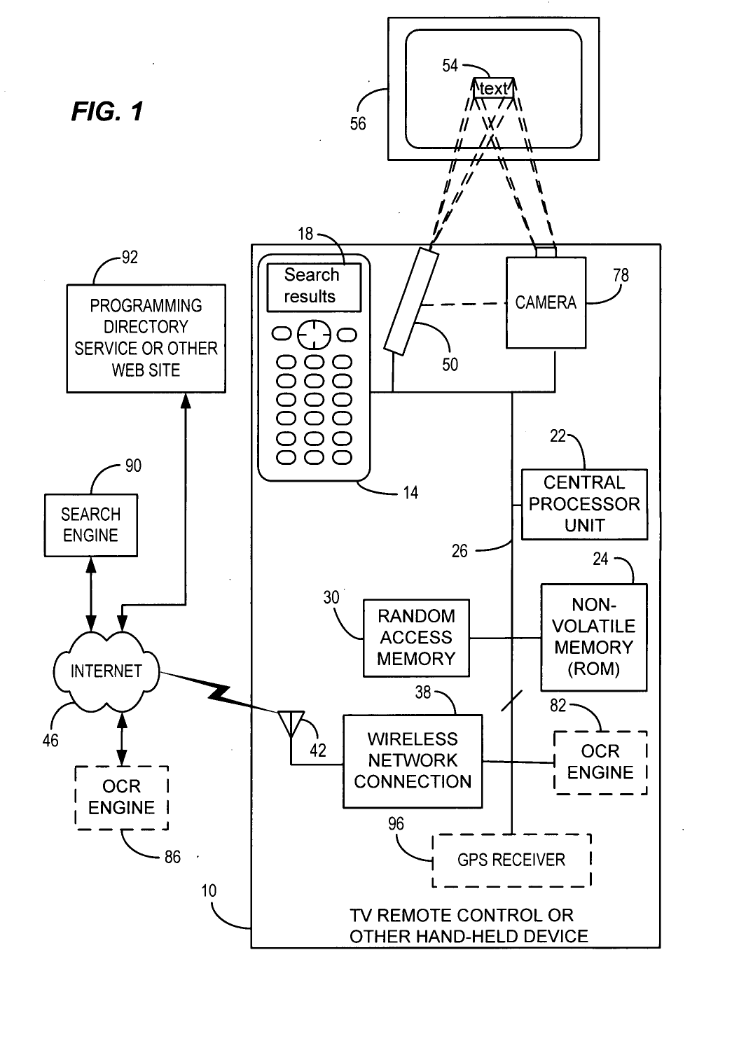

One such device is implemented within a television remote controller device such as that depicted as an exemplary hand-held device 10 of FIG. 1. In this device, the user can be provided with more or less conventional television remote controller functions (many components of which are not shown so as not to obscure the features of interest in connection with embodiments consistent with the present invention). In this embodiment, which may also be implemented in any suitable hand-held device including personal digital assistants (PDAs), wireless telephones, wireless terminals, etc., a user interface 14 is provided which may incorporate a key pad as shown including any suitable set of navigation controls (e.g., an X-Y rocker control, shuttle, touchpad, keys, etc.) and a display 18. The details of circuitry for interfacing and interconnecting such a user interface 14 with a central processor 22 are well known and omitted for clarity in favor of depiction as a bus 26. Central processor unit (CPU) 22 is also connected to Random Access Memory (RAM) 30 and non-volatile memory (e.g., ROM and/or EEROM, etc.) 34 which is used to carry operating system, program and data files in a conventional arrangement.

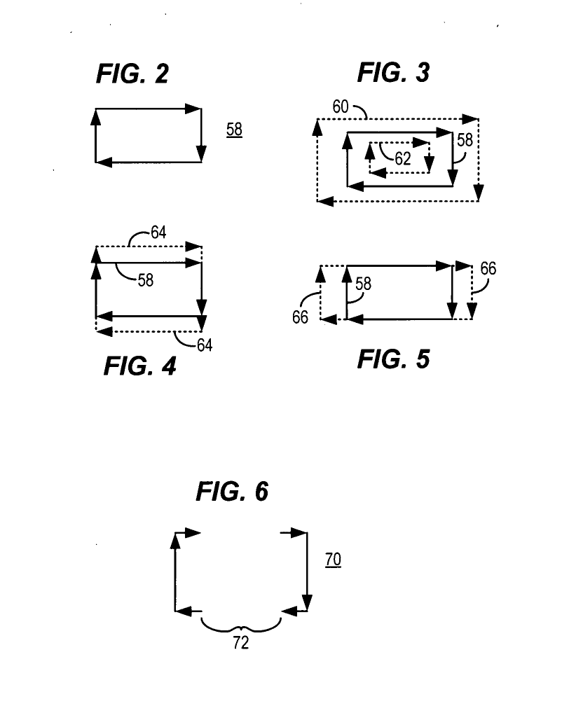

Also incorporated within hand-held device 10 is a wireless communication circuit depicted as 38 for making a network connection, which communicates via antenna 42 to the Internet 46. Of particular interest in this example embodiment, a laser pointer device 50 is incorporated which generates a laser generated image under control of CPU 22. By way of example, as shown in FIG. 1, a box 54 can be generated as a laser light image on a television display 56 or any other segment of a user's field of view (e.g., a book, a sign, billboard, or any other image). The box 54 is generated by continuously deflecting or otherwise moving the laser pointer 50's output in a repetitive up—right—down—left motion (counterclockwise described but clockwise or other piecewise motion could be used) as shown in FIG. 2 in diagram 58.

Cursor controls such as that used in connection with graphics programs can be used to modify the size of the box 54, for example in any one of several ways. Three way control is shown in FIGS. 3-5. In FIG. 3, the overall size of the box can be changed to make it larger (box 60) or smaller (box 62) in all directions without affect on the aspect ratio of the box. Another control can be used to expand or contract the box vertically (box 64) as shown in FIG. 4, and yet another to expand or contract the box horizontally (box 66) as shown in FIG. 5.

Another embodiment is depicted in FIG. 6 in which a pair of brackets 70 are used to select a segment of the image or visual field. Brackets or other designs can be created by modulating the laser light on and off (e.g., off at space 72 and on during the remainder of the path outlined by the arrowed lines. Controls similar to those described above can be similarly used to stretch or elongate the brackets 70.

Returning attention to FIG. 1, the device as pictured can be used to obtain information from any identifiable text that can be captured by use of a digital camera 78 incorporated into the hand-held device. Movement of the laser pointer device 50's image is coordinated with the direction in which the camera is pointed and focused so that the camera either 1) captures only the image within the bracketed or boxed area when possible or 2) processes the image to crop out everything outside the bracketed or boxed area (i.e., the selected segment of the visible field).

In the preferred embodiment, the desired text is bracketed or boxed in by the laser operated by the user. This should not be considered limiting. It should be clear that alternate embodiments for highlighting text may be possible. For example, the laser could simply underline the desired text. Alternatively to brackets, the text could be bounded by bright dual dots and not actual brackets. In addition, it is possible that a single dot at the front of a string of text might be used. In that case, the delimiter might simply be a large amount of “white space” between the current and next word or the identification of a “period” at the end of a string of text. Any of these methods and others are consistent with embodiments the invention.

It may also be possible for the laser to point to the beginning of a string of text with a picture taken, and then point to the end of a string of text with a picture taken. The identification of text in this case uses a comparison of pictures to match features in each, and then see which text was “bracketed” by the sequential dots. It also may, in certain embodiments, require the user to remain relatively motionless and level in the use of the laser. Convention might force the second dot to always be to the right or lower than the first dot.

Since the image produced by the laser light is quite pure in color, identification of the laser path that defines the selected segment of the visible field is readily accomplished by pattern matching techniques. Pattern matching can search the image for the defined laser path (e.g., a box, a pair of brackets, underline, dot with “white space”, dual dots, sequential dots or any other suitable mechanism for bracketing, enclosing highlighting or otherwise specifying a segment of text) that have a particular color attribute. Moreover, by operating in coordination, the pattern can be modulated in a specified manner (e.g., turned on and off at a particular rate) and recognized by the image captured in the camera to confirm that the identified box, bracket, etc. is being sourced by the laser pointer device 50.

Recent generations of laser pointer devices using green light have been noted to be exceedingly bright, and further advances in laser technology are expected to produce laser beams of various other colors that will be suitable for use in this application. In the case of certain commercially available laser pointers with green light, it has been noted that the light intensity easy overwhelms the brightness of light emanating from television displays so that certain embodiments consistent with the current invention can be readily used not only for capturing text from signage, billboards, street signs, books, newspapers, and other text-bearing items in the visible field, but also from images produced from lights including television displays and lighted signs even at considerable distances.

Hence, identification of the selected area of visible field which is of interest to the user can be accomplished by pointing the hand-held device at the general area from which the area is to be selected and then manipulation of controls on the hand held device to bracket, box or otherwise mark the selected image by expanding or contracting the laser image suitably. Once the area has been appropriately marked by the laser pattern, operation of a “select” function causes the camera 78 to capture the image. Depending upon zooming capability of the camera's lens or electronics, the selected area can be maximized in the image to ensure that the best possible resolution of the captured image is accomplished.

Once camera 78 captures the image, it is placed in a suitable memory location (e.g., in a non-volatile memory location 34 which may include, for example a Memory Stick™ or other memory card). The stored image can be displayed on the display 18 for confirmation by the user if desired and then be processed by a computer program running either on central processor 22 or at a remote web site accessed by the Internet in order to extract only the selected area from the image. This can be done as described above cropping out all information except that within the laser light defined boundaries.

At this point, the user has a stored image that has been stripped of all information except for that which is of interest. The stored image can then be analyzed by use of image recognition hardware and/or software. In the preferred application, the image that is selected is text so that analysis can proceed using an OCR engine (This should not be considered limiting, since as will be described later, other image processing can also be carried out.). The image of the text can be processed either locally using OCR engine 82 or remotely by transmission of the cropped image to OCR engine 86 (where presumably greater processing power can be brought to bear) with the results sent back to the hand-held device 10 for further use. As a part of this process, in certain embodiments, a time and/or date stamp can be added as a portion of metadata associated with the captured image.

Once the image is processed by OCR engine 82 or 86, any number of actions can take place. In one embodiment, the captured text may, for example, be the title of a television program. In such case, this title can be loaded into a browser as the query text for a search to be carried out on the Internet 46, using for example search engine 90. The search results can be displayed on display 18 from which a user may select, for example a programming directory site 92 which provides further information about the selected programming including ratings, synopsis, actors, links to further information, airing times, electronic programming guide information, or other metadata associated with the television program.

In other embodiments, the text can be stored by the user for use in other applications. Consider for example the incorporation of global positioning system information into the mix. An image captured can be read using OCR technology and incorporated as metadata associated with diary entry, database or photo documentation. For example, the location where the user is situated can be obtained by GPS receiver 96 and stored along with a photo image and text captured from the image. Thus, a user who finds a restaurant that he likes and wishes to remember can take a photo of the restaurant, capture text from the signage for the restaurant, automatically name the file using the captured text and store associated metadata including time, date and GPS coordinates for the restaurant for later retrieval. The restaurant can thus be added to a database of available establishments that can be retrieved by the GPS circuitry to enable to user to readily find the establishment in the future.

Many variations will occur to those skilled in the art upon consideration of the present teachings. For example, the captured text may also be stored to a file to create a simple text reminder (e.g., a memory aid).

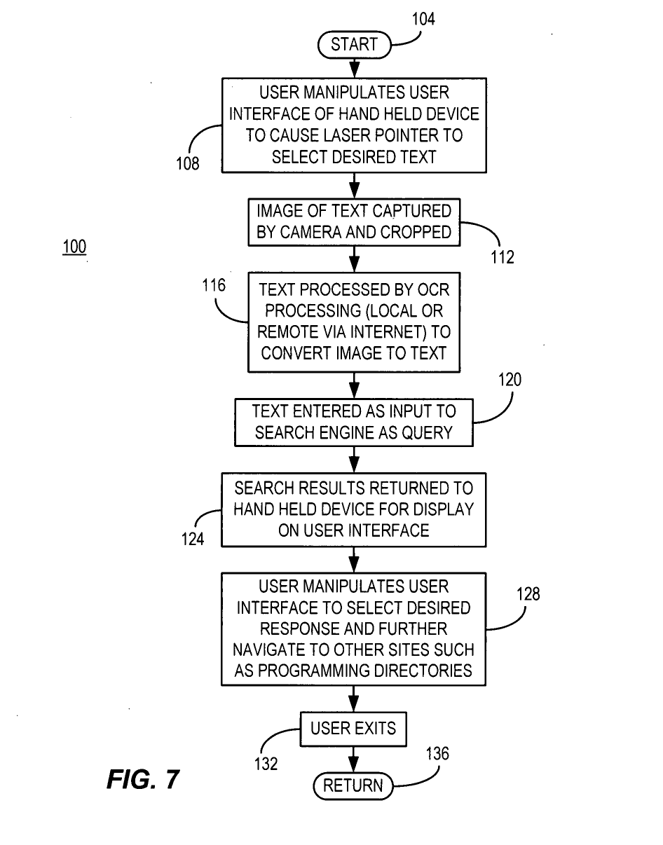

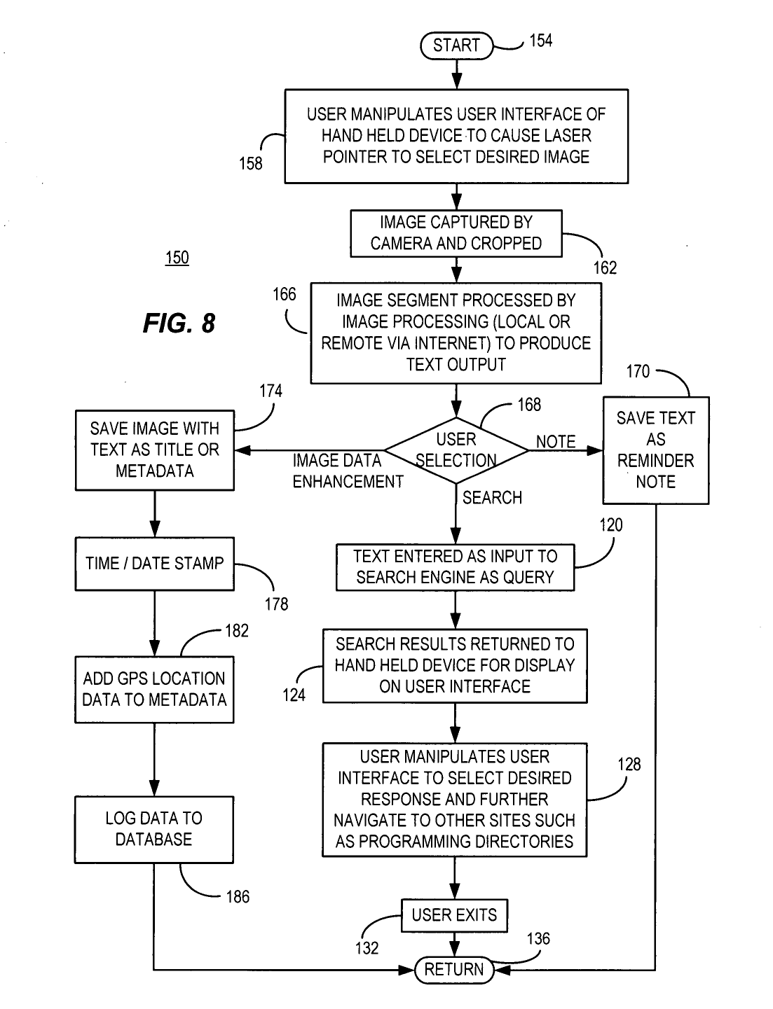

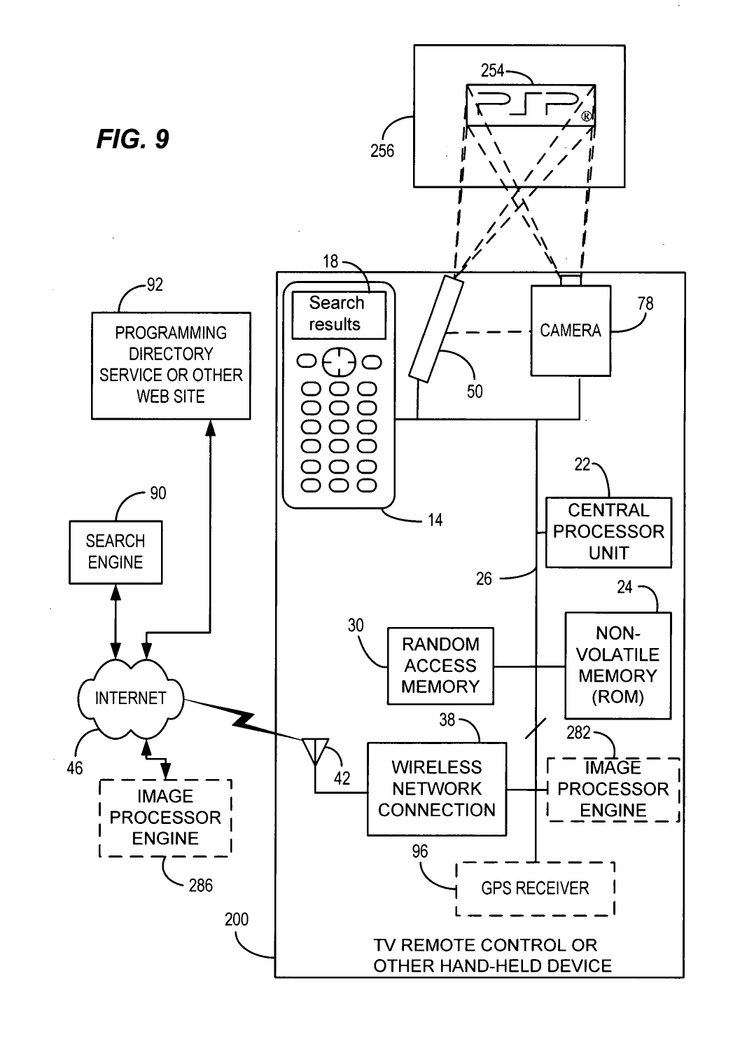

In one process 100 depicted in FIG. 7, the television directory embodiment discussed is depicted in flow chart form starting at 104. At 108, the user manipulates the user interface 18 of device 10 to cause the laser pointer to select the desired segment of the visible field. Once selected, the image is captured at 112 by the camera 78. The image may be cropped at this stage to eliminate extraneous image area captured by the camera. The text or other image remaining is then analyzed by the OCR or other image processing engine at 116—with such engine being either local to the hand-held device 10, or remote to the hand-held device 10 and accessed via wireless connection to the Internet.

Once the image is converted to text, the text can be loaded as a query to a search engine 90 at 120. The search results are returned to the user at 124 for display on the user interface display 18 (or other suitable display mechanism). The user can then manipulate the user interface at 128 to select a desired response to the query or navigate to other sites as desired (e.g., a programming directory or directory specific to the interest of the user). Navigation at 128 to various sites can be carried out in a typical browsing methodology that varies from this point depending upon where the search leads until the user is done at which point he exits at 132 and the process returns at 136.

Another embodiment is depicted in FIG. 8 in which process 150 starts at 154 after which the user manipulates a hand-held device to cause the laser pointer to select a desired segment of a field of view (an image segment). In this case, the image segment can be text, a logo or other identifiable visible attribute of the field of view. At 162, the image is captured by the camera and cropped to reduce or eliminate the excess image for further processing. The image segment is then processed by an image processing engine (again either local or remote via the Internet) to produce output text. In this example, the image may not be an image of text, but may in fact be a logo, trademark or other indicia or recognizable image (e.g., a face or architectural feature). The output text may be a description of that which is captured in the image, or may be an OCR interpretation of the image. At 168, in this exemplary process, the user can decide at 168 among several possibilities of what to do with the information once retrieved.

In a first embodiment, the user can elect to use the text as a search. In this case, the text output from image analysis can be entered as text input to a search engine at 120 as in the prior example. In this case, blocks 124, 128, 132 and 136 are carried out as previously described.

In another embodiment, the user can elect to store the information as a note and control passes to 170 where the text is saved as a note or database entry, possibly incorporating a location, time and/or date stamp after which the process returns at 136. In another embodiment, the user can utilize the data for image metadata enhancement. The image, or a related image separately captured can be saved with the text results as a portion of the title of the image or as metadata associated with the image at 174. This image can also be date and/or time stamped at 178 and/or location stamped at 182 with data from the GPS receiver. This information can also be logged to a database at 186 before the process returns at 136. Many variations, choices and combinations thereof can be incorporated into the process without departing from embodiments consistent with the present invention.

In certain embodiments, as previously noted, the captured segment of the visual field may in fact be a graphic image or other image that may not be recognizable by OCR processing or OCR processing alone. The present invention contemplates other variants of image processing including pattern matching, neural network processing, fuzzy logic and other techniques to identify images that are not readily identifiable. Such images include, but are not limited to stylized text, logos, trademarks, graphics, insignias, faces, landscapes, architectural elements, and any other recognizable visual element. In the example shown, the Sony Corporation trademark shown is a stylized PSP® (PlayStation Portable) logo blocked in by block 254 for example from an advertisement 256 that might not be recognized by OCR processes alone, but might be readily matched to an index of logos. Other logos will be even more difficult to correctly identify using OCR techniques alone given that many are simply graphic images.

In such cases, the hand-held device 200 as depicted in FIG. 9 resembles that of hand-held device 10 of FIG. 1 except that the OCR processing is more broadly represented by image processing engines 282 and 286 which can be local, remote or distributed. This information can then be used as described above in a search engine, other web sites or in other manners.

Thus, a method of processing image data consistent with certain embodiments involves defining a segment of a visual field using a laser pointer; capturing an image of the segment of the visual field; and processing the captured segment to produce associated text associated with the selected segment.

A hand-held electronic device consistent with certain embodiments has a laser pointer device that is manipulable to identify a selected segment of a visible field. A camera captures an image that includes the selected segment. A processor image processes the selected segment appearing in the image captured by the camera to produce associated text associated with the selected segment.

In certain embodiments, the image processor is an OCR processing engine and residing within the hand-held device. In certain embodiments, a display displays the associated text. In certain embodiments, image content outside the selected segment is cropped out prior to image processing. In certain embodiments, a wireless interface or other interface is provided for communication with the Internet. In certain embodiments, the image processing involves an image processing engine residing at a remote location that is accessed via the Internet, and at least a portion of the image containing the selected segment is transmitted via the Internet for processing by the image processing engine In certain embodiments, the associated text is input to a search engine as a query. In certain embodiments, a display that displays results from said query. In certain embodiments, the selected segment is taken from a television display, and the results from the query are obtained from a television directory service. In certain embodiments, the laser pointer device is manipulable to expand and contract the size of a pattern that shines on the visible field.

In another embodiment, a hand-held electronic device has a laser pointer device that is manipulable to identify a selected segment of a visible field. A camera captures an image that includes the selected segment. An for optical character recognition (OCR) engine is provided for processing of the selected segment appearing in the image captured by the camera to recognize text appearing in the selected segment.

In certain embodiments, the OCR processing engine is resides within the hand-held device. In certain embodiments, a display displays the recognized segment. In certain embodiments, image content outside the selected segment is cropped out prior to OCR processing. In certain embodiments, a mechanism is provided for communication with the Internet. In certain embodiments, the OCR processing engine resides at a remote location that is accessed via the Internet, and at least a portion of the image containing the selected segment is transmitted to the Internet for processing by the OCR engine. In certain embodiments, the recognized text is input to a search engine as a query In certain embodiments, a display displays results from said query. In certain embodiments, the selected segment is taken from a television display, and the results from the query are obtained from a television directory service In certain embodiments, the laser pointer device is manipulable to expand and contract the size of a pattern that shines on the visible field. In certain embodiments the laser pointer device is manipulable to shine a dot at the beginning of a string of text on the visible field. In certain embodiments the laser pointer device is manipulable to shine a dot at the beginning and, at the end of a string of text on the visible field. In certain embodiments the laser pointer device is manipulable to identify a string of text by use of a box or brackets.

Those skilled in the art will recognize, upon consideration of the above teachings, that certain of the above exemplary embodiments are based upon use of a programmed processor such as CPU 22. However, the invention is not limited to such exemplary embodiments, since other embodiments could be implemented using hardware component equivalents such as special purpose hardware and/or dedicated processors. Similarly, general purpose computers, microprocessor based computers, micro-controllers, optical computers, analog computers, dedicated processors, application specific circuits and/or dedicated hard wired logic may be used to construct alternative equivalent embodiments.

Certain embodiments described herein, are or may be implemented using a programmed processor executing programming instructions that are broadly described above in flow chart form that can be stored on any suitable electronic or computer readable electronic storage medium and/or can be transmitted over any suitable electronic communication medium. However, those skilled in the art will appreciate, upon consideration of the present teaching, that the processes described above can be implemented in any number of variations and in many suitable programming languages without departing from embodiments of the present invention. For example, the order of certain operations carried out can often be varied, additional operations can be added or operations can be deleted without departing from certain embodiments of the invention. Error trapping can be added and/or enhanced and variations can be made in user interface and information presentation without departing from certain embodiments of the present invention. Such variations are contemplated and considered equivalent.

While certain illustrative embodiments have been described, it is evident that many alternatives, modifications, permutations and variations will become apparent to those skilled in the art in light of the foregoing description.

What is claimed is:

1. A hand-held electronic device, comprising:
a laser pointer device that is manipulable to identify a selected segment of a visible field;
a camera that captures an image that includes the selected segment; and
means for image processing the selected segment appearing in the image captured by the camera to produce associated text associated with the selected segment.

2. The hand-held electronic device according to claim 1, wherein the means for image processing comprises OCR processing the selected segment comprises an OCR engine residing within the hand-held device.

3. The hand-held electronic device according to claim 1, further comprising a display that displays the associated text.

4. The hand-held electronic device according to claim 1, wherein image content outside the selected segment is cropped out prior to image processing.

5. The hand-held electronic device according to claim 1, further comprising means for communication with the Internet.

6. The hand-held electronic device according to claim 5, wherein the means for image processing the selected segment comprises an image processing engine residing at a remote location that is accessed via the Internet, and wherein at least a portion of the image containing the selected segment is transmitted by the means for communication with the Internet for processing by the image processing engine.

7. The hand-held electronic device according to claim 5, wherein the associated text is input to a search engine as a query.

8. The hand-held electronic device according to claim 7, further comprising a display that displays results from said query.

9. The hand-held electronic device according to claim 8, wherein the selected segment is taken from a television display, and wherein the results from the query are obtained from a television directory service.

10. The hand-held electronic device according to claim 1, wherein the laser pointer device is manipulable to expand and contract the size of a pattern that shines on the visible field.

11. The hand-held electronic device according to claim 1, wherein the laser pointer device is manipulable to shine a dot at the beginning of a string of text on the visible field.

12. The hand-held electronic device according to claim 1, wherein the laser pointer device is manipulable to shine a dot at the beginning and, at the end of a string of text on the visible field.

13. The hand-held electronic device according to claim 1, wherein the laser pointer device is manipulable to identify a string of text by use of a box or brackets.

14. A hand-held electronic device, comprising:
a laser pointer device that is manipulable to identify a selected segment of a visible field;
a camera that captures an image that includes the selected segment; and
means for optical character recognition (OCR) processing of the selected segment appearing in the image captured by the camera to recognize text appearing in the selected segment.

15. The hand-held electronic device according to claim 14, wherein the means for OCR processing the selected segment comprises an OCR engine residing within the hand-held device.

16. The hand-held electronic device according to claim 14, further comprising a display that displays the recognized segment.

17. The hand-held electronic device according to claim 14, wherein image content outside the selected segment is cropped out prior to OCR processing.

18. The hand-held electronic device according to claim 14, further comprising means for communication with the Internet.

19. The hand-held electronic device according to claim 18, wherein the means for OCR processing the selected segment comprises an OCR engine residing at a remote location that is accessed via the Internet, and wherein at least a portion of the image containing the selected segment is transmitted by the means for communication with the Internet for processing by the OCR engine.

20. The hand-held electronic device according to claim 14, wherein the recognized text is input to a search engine as a query.

21. The hand-held electronic device according to claim 20, further comprising a display that displays results from said query.

22. The hand-held electronic device according to claim 21, wherein the selected segment is taken from a television display, and wherein the results from the query are obtained from a television directory service.

23. The hand-held electronic device according to claim 14, wherein the laser pointer device is manipulable to expand and contract the size of a pattern that shines on the visible field.

24. The hand-held electronic device according to claim 14, wherein the laser pointer device is manipulable to shine a dot at the beginning of a string of text on the visible field.

25. The hand-held electronic device according to claim 14, wherein the laser pointer device is manipulable to shine a dot at the beginning and, at the end of a string of text on the visible field.

26. The hand-held electronic device according to claim 14, wherein the laser pointer device is manipulable to identify a string of text by use of a box or brackets.

27. A hand-held electronic device, comprising:
a laser pointer device that is manipulable to identify a selected segment of a visible field;
a camera that captures an image that includes the selected segment, wherein image content outside the selected segment is cropped out prior to OCR processing;
an optical character recognition (OCR) engine residing on the hand-held device that processes the selected segment appearing in the image captured by the camera to recognize text appearing in the selected segment;
a display that displays the recognized segment; and
means for communication with the Internet.

28. The hand-held electronic device according to claim 27, wherein the recognized text is input to a search engine as a query.

29. The hand-held electronic device according to claim 28, further comprising a display that displays results from said query.

30. The hand-held electronic device according to claim 29, wherein the selected segment is taken from a television display, and wherein the results from the query are obtained from a television directory service.

31. The hand-held electronic device according to claim 27, wherein the laser pointer device is manipulable to shine a dot at the beginning of a string of text on the visible field.

32. The hand-held electronic device according to claim 27, wherein the laser pointer device is manipulable to shine a dot at the beginning and, at the end of a string of text on the visible field.

33. The hand-held electronic device according to claim 27, wherein the laser pointer device is manipulable to identify a string of text by use of a box or brackets.

34. A method of processing image data, comprising:
defining a segment of a visual field using a laser pointer
capturing an image of the segment of the visual field; and
processing the captured segment to produce associated text associated with the selected segment.

35. The method according to claim 34, wherein the image processing comprises OCR processing the selected segment.

36. The method according to claim 34, further comprising a display that displays the associated text.

37. The method according to claim 34, further comprising cropping the image content outside the selected segment prior to image processing.

38. The method according to claim 34, further comprising means for communication with the Internet.

39. The method according to claim 34, wherein the associated text is input to a search engine as a query.

40. The method according to claim 39, further comprising displaying results from said query.

41. The method according to claim 40, wherein the selected segment is taken from a television display, and wherein the results from the query are obtained from a television directory service.

42. The method according to claim 40, wherein the laser pointer device is manipulable to expand and contract the size of a pattern that shines on the visible field.

43. The method according to claim 34, wherein defining comprises manipulating the laser pointer to shine a dot at the beginning of a string of text on the visible field.

44. The method according to claim 34, wherein defining comprises manipulating the laser pointer to shine a dot at the beginning and the end of a string of text on the visible field.

45. The method according to claim 34, wherein defining comprises manipulating the laser pointer to identify a string of text by use of a box or brackets.

46. A computer readable storage medium storing instructions which, when executed on a programmed processor, carry out a process according to claim 34.
